(19) United States
(12) Patent Application Publication
(10) Pub. No.: US 2007/0157238 A1
(43) Pub. Date: Jul. 5, 2007

(54) Advertising method in a DVR system

(75) Inventors: Ke-Chieh Tso, Chung Ho City (TW); Shou-Kang Wei, Chung Ho City (TW); Chi-Hsien Shih, Chung Ho City (TW)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: AverMedia Technologies, Inc., Chung Ho City (TW)

(21) Appl. No.: 11/330,731

(22) Filed: Jan. 4, 2006

(51) Int. Cl. H04N 7/025; H04N 7/10; G06F 3/00; G06F 13/00; H04N 5/445

(52) U.S. Cl. 725/42; 725/32

(57) ABSTRACT

The present invention provides an advertising method for a DVR system. First, a monitor display of the DVR system is separated into a main display region and a banner display region. The main display region is used to broadcast a live scene. The banner display region is used to display an advertisement icon provided by an advertiser. The advertisement content can be renewed in real time by the advertiser through the Internet.

### FIELD OF THE INVENTION

The present invention is related to an advertising method, and more particularly to an advertising method in a digital video recording (DVR) monitor system.

### BACKGROUND OF THE INVENTION

Crime is becoming more and more serious worldwide. Consequently, people are paying much attention to security measures, and requirements of electronic security equipment is thus increasing.

Generally speaking, the digital video recorder (DVR) system has replaced the analog video recorder system to become the preferred security equipment because the video can be compressed in the DVR system to save storage space and provide better portability.

Although there is a large potential market for the DVR system, its expensive price is an obstacle to increase market share. Therefore, manufacturers desire methods to overcome this obstacle.

### SUMMARY OF THE INVENTION

The main purpose of the present invention is to provide an advertising method in a DVR system so as to generate advertisement revenue to compensate the DVR system price.

Another purpose of the present invention is to provide a low cost DVR system.

A further purpose of the present invention is to provide an advertisement platform to expand the advertising range.

According to the foregoing purposes, the present invention provides an advertising method in a DVR system. First, a display monitor of the DVR system is separated into a main display region and a banner display region. The main display region is used to broadcast the live scene. The banner display region is used to display an advertisement icon provided by an advertiser, wherein the advertisement content can be renewed in real time by the advertiser through the Internet.

According to the present invention, the DVR system producer can charge the advertiser to compensate the selling price. Therefore, the price of the DVR system can be reduced to reach the goal of enlarging the market share. Furthermore, the present invention provides an additional advertisement platform for advertisers. The main viewers are the inhabitants of a community, so the advertisement content is tailored to these viewers to increase the efficiency of the advertisement.

### BRIEF DESCRIPTION OF THE DRAWINGS

The foregoing aspects and many of the attendant advantages of this invention are more readily appreciated and better understood by referencing the following detailed description, when taken in conjunction with the accompanying drawings, wherein:

FIG. 1 is a typical screen of a DVR system;

FIG. 2A is a screen of a DVR system according to the preferred embodiment of the present invention;

FIG. 2B is a display monitor of a DVR system according to another embodiment of the present invention; and

FIGS. 3 is a schematic diagram of a DVR system according to the preferred embodiment of the present invention.

### DETAILED DESCRIPTION OF THE PREFERRED EMBODIMENT

The main difference between the DVR system and an analog video recorder system is that the DVR system may monitor a remote locality through the Internet. Therefore, many locations may be monitored from a centralized office to increase the security.

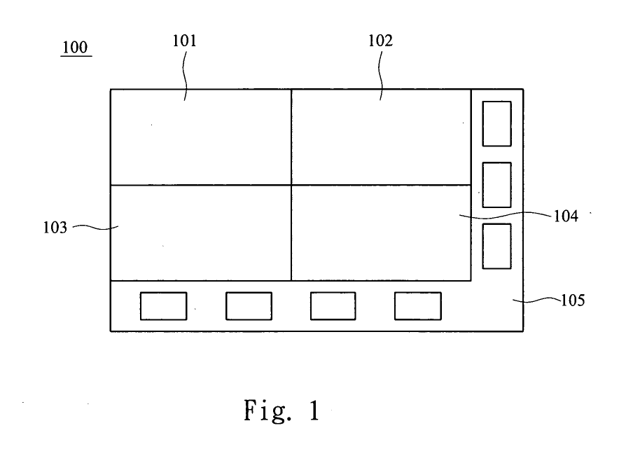

FIG. 1 is a screen that shows four live scenes of four remote localities respectively. This screen 100 includes four main display regions 101, 102, 103 and 104, and a control region 105. The four main display regions 101, 102, 103 and 104 display the live scenes of four remote localities respectively. The control region 105 is a user interface to display control buttons for a user to select.

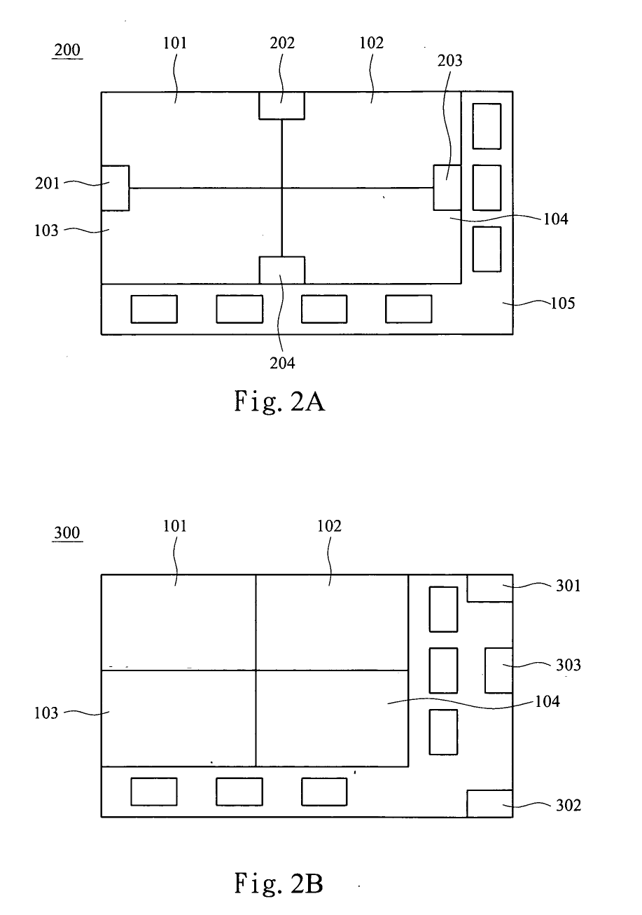

The advertisement method of the present invention is to insert the advertisement icons in the screen 200 as shown in FIG. 2A. The icons 201, 202, 203 and 204 represent different advertisement content. In an embodiment, an icon is scrolling text for introducing a product. In another embodiment, an icon is a trademark of a product. When a user selects an icon, the corresponding advertisement content is displayed in the screen. In an embodiment, a counter is used to count the number of times each icon has been selected to use as market research. According to another embodiment, the advertisement icons 301, 302 and 303 are inserted into the control region 105 as shown in FIG. 2B. Moreover, in other embodiment, the icons can be inserted into the main display region and the control region.

It is noticed that, the DVR system producer and the buyer may together determine the number and the position of the advertisement icons in the screen. For example, when more advertisement icons are shown on the screen, the producer may reduce the selling price of the DVR system because the reduced selling price is compensated by the advertisement revenue.

The advertisement content is determined when the DVR system is equipped. In other words, the advertisement content is pre-recorded in the setup medium. Therefore, when a DVR system is initialized through this medium, the advertisement content is uploaded to the DVR system at the same time, and when the DVR system is booted, the advertisement icons are displayed in certain positions on the screen.

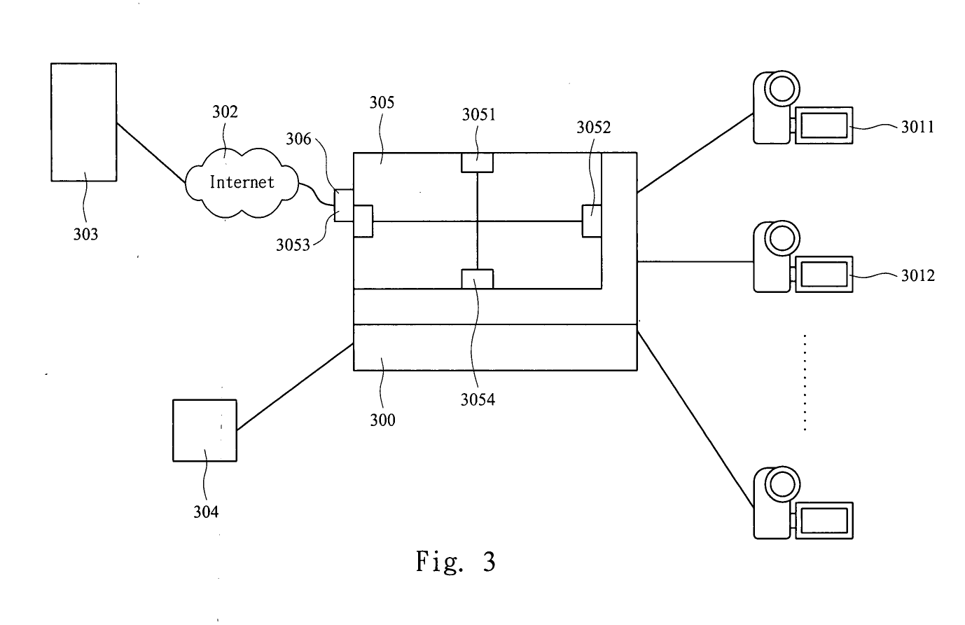

FIG. 3 illustrates a schematic diagram of a DVR system according to the preferred embodiment of the present invention. This DVR system includes a host 300, some camera systems 3011, 3012 connecting with the host 300. The host 300 has a display 305 for displaying live scenes that are captured by camera systems 3011, 3012. Some advertisement icons 3051, 3052, 3053 and 3054 are displayed on the display 305; and the advertisement icons may be displayed in the main display region, the control region, or both as described in the foregoing paragraphs.

Moreover, two advertisement content renewal methods are provided in the present invention. One method is through scheduled maintenance of the DVR system. For example, a medium with new advertisement content is placed into the optical recorder 304 to renew the old content by the maintenance staff. The other method is through a connection unit 306 to connect with the Internet 302 in order to communicate with advertisers 303 to renew the advertisement content real time.

To avoid missing criminal activity due to browsing advertisements, the browsing advertisement execution can be automatically minimized in real time when the activity happens. For example, the activity can be determined by comparing the pictures of two adjacent time points to assess whether or not a predetermined pixel change happens. Once a predetermined pixel change happens, the situation is defined as potential criminal activity. At this time, the display 305 is forced to switch to the live scene.

Accordingly, the advertising method of the present invention is to insert some advertisement icons into the screen. According to the method, the advertisement revenue may compensate the selling price of the DVR system. Therefore, the selling price can be reduced to increase market share. Since the monitoring systems are usually used in residential communities, the advertisement content can be tailored to the people living in the community so as to increase advertising efficiency. A counter can also be used to count the number of times each icon has been selected to use as market research.

Therefore, the present invention has the following advantages. First, the DVR system producer can charge the advertiser to compensate the selling price. Therefore, the price of the DVR system can be reduced to reach the goal of enlarging the market share. Second, the present invention provides an additional advertisement platform for advertisers. The main viewers are inhabitants of residential communities, so advertisement content is mainly aimed at these viewers to increase advertising efficiency.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. An advertising method used in a monitor system, wherein said monitor system is used to monitor at least one position and includes a display, comprising:
displaying at least one monitor image and a control image in the screen of said display, wherein said monitor image is a live scene of said position and said control image is a user interface; and
displaying at least one advertisement icon in the screen of said display.

2. The advertising method of claim 1, wherein said monitor system further comprises a medium recorder for uploading said at least one advertisement icon data to said monitor system.

3. The advertising method of claim 1, wherein said advertisement icon data is uploaded to said monitor system through the Internet.

4. The advertising method of claim 1, wherein when said advertisement icon is selected, a corresponding advertisement content is displayed in the screen of said display.

5. The advertising method of claim 4, wherein said monitor system further comprises a counter to count the number of times said advertisement icon has been selected.

6. The advertising method of claim 1, wherein said advertisement icon is scrolling text for introducing a product.

7. The advertising method of claim 1, wherein said advertisement icon is a trademark of a product.

8. The advertising method of claim 1, wherein said advertisement icon is inserted into said monitor image.

9. The advertising method of claim 1, wherein said advertisement icon is inserted into said control image.

10. The advertising method of claim 1, wherein said advertisement icon is inserted into said monitor image and said control image.

11. The advertising method of claim 1, further comprising switching to said monitor image when an irregular situation happens.

12. A monitor system, wherein said monitor system stores at least one advertisement data, comprising:
at least one camera device to monitor at least one position; and
a display, said display for displaying at least one monitor image, a control image and at least one advertisement image in the screen of said display, wherein said monitor image is a live scene of said position and said control image is a user interface.

13. The monitor system of claim 12, further comprising a medium recorder for uploading said at least one advertisement image data to said monitor system.

14. The monitor system of claim 12, further comprising an Internet connecting device for connecting with the Internet, wherein said advertisement icon image is uploaded to said monitor system through the Internet.

15. The monitor system of claim 12, wherein said advertisement image is a trademark of a product.

16. The monitor system of claim 12, wherein said advertisement image is an icon and when said icon is selected, a corresponding advertisement content is displayed in the screen of said display.

17. The monitor system of claim 16, further comprising a counter to count the number of times said icon has been selected.

18. The monitor system of claim 12, wherein said advertisement image is scrolling text for introducing a product.

19. The monitor system of claim 12, wherein said advertisement image is inserted into said monitor image.

20. The monitor system of claim 12, wherein said advertisement image is inserted into said control image.

21. The monitor system of claim 12, wherein said advertisement image is inserted into said monitor image and said control image.
